(19) United States
(12) Patent Application Publication
(10) Pub. No.: US 2026/0321807 A1
(43) Pub. Date: Oct. 15, 2026

(54) ELECTROCHEMICAL APPARATUS AND ELECTRICAL DEVICE

(71) Applicant: Ningde Amperex Technology Limited, Ningde (CN)

(72) Inventor: Tengteng CHEN, Ningde (CN)

(73) Assignee: Ningde Amperex Technology Limited, Ningde (CN)

(21) Appl. No.: 19/691,888

(22) Filed: May 29, 2026

Related U.S. Application Data
(63) Continuation of application No. PCT/CN2024/102094, filed on Jun. 27, 2024.

(30) Foreign Application Priority Data
Nov. 30, 2023 (CN) 202311641263.6

(51) Int. Cl. H01M 50/103; H01M 10/0525; H01M 10/0587; H01M 50/131; H01M 50/14

(52) U.S. Cl. CPC H01M 50/103; H01M 10/0587; H01M 50/131; H01M 50/14; H01M 10/0525

(57) ABSTRACT

An electrochemical apparatus, including an electrode assembly and a housing. The housing includes a first bottom wall and a second bottom wall disposed opposite to each other along a first direction, a first sidewall and a second sidewall disposed opposite to each other along a second direction, and a third sidewall and a fourth sidewall disposed opposite to each other along a third direction. The electrode assembly is accommodated in the housing. The first sidewall includes a first base portion and a first protrusion. The first protrusion connects the first base portion and the third sidewall. An outer surface of the first protrusion protrudes beyond an outer surface of the first base portion along the second direction. An inner surface of the first protrusion is recessed relative to an inner surface of the first base portion in a direction away from the electrode assembly.

### CROSS-REFERENCE TO RELATED APPLICATIONS

This application is a continuation application of PCT International Application No. PCT/CN2024/102094, filed on Jun. 27, 2024, which claims priority to Chinese Patent Application No. 202311641263.6, filed on Nov. 30, 2023 and entitled “ELECTROCHEMICAL APPARATUS AND ELECTRICAL DEVICE”, which is incorporated herein by reference in its entirety.

### TECHNICAL FIELD

This application relates to the technical field of battery, and in particular, to an electrochemical apparatus and electrical device.

### BACKGROUND

Electrochemical apparatuses are widely used in the fields such as portable electronic devices, electric vehicles, electric tools, drones, and energy storage devices. With the increase in energy density of electrochemical apparatuses and the diversification of application environments, higher requirements are imposed on the reliability of electrochemical apparatuses during use.

### SUMMARY

In view of the above problems, this application provides an electrochemical apparatus and an electrical device to improve the reliability of the electrochemical apparatus.

A first aspect of this application provides an electrochemical apparatus. The electrochemical apparatus includes an electrode assembly and a housing. The housing includes a first bottom wall and a second bottom wall disposed opposite to each other along a first direction, a first sidewall and a second sidewall disposed opposite to each other along a second direction, and a third sidewall and a fourth sidewall disposed opposite to each other along a third direction. The first direction is a thickness direction of the electrode assembly. The first direction, the second direction, and the third direction are perpendicular to each other. The first sidewall, the second sidewall, the third sidewall, the fourth sidewall, the first bottom wall, and the second bottom wall jointly enclose and define an accommodation space. The electrode assembly is accommodated in the accommodation space. The first sidewall includes a first base portion and a first protrusion. The first protrusion connects the first base portion and the third sidewall. An outer surface of the first protrusion protrudes beyond an outer surface of the first base portion along the second direction. An inner surface of the first protrusion is recessed relative to an inner surface of the first base portion in a direction away from the electrode assembly.

In the electrochemical apparatus of this application, by providing the first protrusion on the first sidewall, this application makes corner positions of the electrode assembly less prone to hit the first sidewall when the electrode assembly expands. In addition, due to a height difference between the first protrusion and the first base portion, when the housing expands along the first direction, the first bottom wall and/or the second bottom wall pulls the first sidewall, causing the first sidewall to collapse and deform. In this process, the electrode assembly first contacts the first base portion to form a support, thereby alleviating the compression exerted by the electrode assembly on the corners of the housing, reducing the risk of damage at the corners of the housing, and improving the reliability of the electrochemical apparatus during use.

In any one or more optional embodiments, the first sidewall further includes a second protrusion. The second protrusion connects the first base portion and the fourth sidewall. An outer surface of the second protrusion protrudes beyond the outer surface of the first base portion along the second direction. An inner surface of the second protrusion is recessed relative to the inner surface of the first base portion in the direction away from the electrode assembly. In this way, the first sidewall includes the first protrusion and the second protrusion, thereby reducing the risk of damage at the corners on both sides of the housing, and improving the reliability of the electrochemical apparatus during use.

In any one or more optional embodiments, along the second direction, a distance between the outer surface of the first base portion and an outer surface of the second sidewall is L, and a height by which the first protrusion protrudes beyond the outer surface of the first base portion is l₁, satisfying: 0.005L≤l₁≤0.1L.

In any one or more optional embodiments, along the third direction, a distance between an outer surface of the third sidewall and an outer surface of the fourth sidewall is W, and a width of the first protrusion is w₁, satisfying: 0.05W≤w₁≤0.3W.

In any one or more optional embodiments, along the second direction, a distance between the outer surface of the first base portion and an outer surface of the second sidewall is L, and a height by which the second protrusion protrudes beyond the outer surface of the first base portion is l₂, satisfying: 0.005L≤l₂≤0.1L.

In any one or more optional embodiments, along the third direction, a distance between an outer surface of the third sidewall and an outer surface of the fourth sidewall is W, and a width of the second protrusion is w₂, satisfying: 0.05W≤w₂≤0.3W.

The above technical solution not only improves the reliability of the electrochemical apparatus, but also endows the electrochemical apparatus with a relatively high volumetric energy density.

In any one or more optional embodiments, the third sidewall includes a third base portion and a third protrusion. The third protrusion connects the third base portion and the first protrusion. An outer surface of the third protrusion protrudes beyond an outer surface of the third base portion along the third direction. An inner surface of the third protrusion is recessed relative to an inner surface of the third base portion in the direction away from the electrode assembly. In this way, by providing the third protrusion on the third sidewall, this application makes corner positions of the electrode assembly less prone to hit the third sidewall when the electrode assembly expands. In addition, due to a height difference between the third protrusion and the third base portion, when the housing expands along the first direction, the first bottom wall and/or the second bottom wall pulls the third sidewall, causing the third sidewall to collapse and deform. In this process, the electrode assembly first contacts the third base portion to form a support, thereby further alleviating the compression exerted by the electrode assembly on the corners of the housing, reducing the risk of damage at the corners of the housing, and further improving the reliability of the electrochemical apparatus during use.

In any one or more optional embodiments, the fourth sidewall includes a fourth base portion and a fourth protrusion. The fourth protrusion connects the fourth base portion and the second protrusion. An outer surface of the fourth protrusion protrudes beyond an outer surface of the fourth base portion along the third direction. An inner surface of the fourth protrusion is recessed relative to an inner surface of the fourth base portion in the direction away from the electrode assembly. In this way, by providing the fourth protrusion on the fourth sidewall, this application makes the corner positions of the electrode assembly less prone to hit the fourth sidewall when the electrode assembly expands. In addition, due to a height difference between the fourth protrusion and the fourth base portion, when the housing expands along the first direction, the first bottom wall and/or the second bottom wall pulls the fourth sidewall, causing the fourth sidewall to collapse and deform. In this process, the electrode assembly first contacts the fourth base portion to form a support, thereby further alleviating the compression exerted by the electrode assembly on the corners of the housing, reducing the risk of damage at the corners of the housing, and further improving the reliability of the electrochemical apparatus during use.

In any one or more optional embodiments, along the third direction, a distance between the outer surface of the third base portion and an outer surface of the fourth sidewall is W, and a height by which the third protrusion protrudes beyond the outer surface of the third base portion is w₃, satisfying: 0.05W≤w₃≤0.3W.

In any one or more optional embodiments, along the second direction, a distance between the outer surface of the first base portion and an outer surface of the second sidewall is L, and a width of the third protrusion is 13, satisfying: 0.005L≤l₃≤0.1L.

In any one or more optional embodiments, along the third direction, a distance between the outer surface of the fourth base portion and an outer surface of the third sidewall is W, and a height by which the fourth protrusion protrudes beyond the outer surface of the fourth base portion is w₄, satisfying: 0.05W≤w₄≤0.3W.

In any one or more optional embodiments, along the second direction, a distance between the outer surface of the first base portion and an outer surface of the second sidewall is L, and a width of the fourth protrusion is l₄, satisfying: 0.005L≤l₄≤0.1L.

The above technical solution not only further improves the reliability of the electrochemical apparatus, but also endows the electrochemical apparatus with a relatively high volumetric energy density.

In one or more optional embodiments, the first bottom wall includes a first main portion and a fifth protrusion. The fifth protrusion is located in a corner region of the first bottom wall. The fifth protrusion connects the first protrusion and the third protrusion. An outer surface of the fifth protrusion protrudes beyond an outer surface of the first main portion along the first direction. An inner surface of the fifth protrusion is recessed relative to an inner surface of the first main portion in the direction away from the electrode assembly. In this way, due to a height difference between the fifth protrusion and the first main portion, when the housing expands along the first direction, the pulling force at the corners is alleviated, thereby further alleviating the compression exerted by the electrode assembly on the corners of the housing, reducing the risk of damage at the corners of the housing, and further improving the reliability of the electrochemical apparatus during use.

In one or more optional embodiments, the first bottom wall includes a first main portion and a sixth protrusion. The sixth protrusion is located in a corner region of the first bottom wall. The sixth protrusion connects the second protrusion and the fourth protrusion. An outer surface of the sixth protrusion protrudes beyond an outer surface of the first main portion along the first direction. An inner surface of the sixth protrusion is recessed relative to an inner surface of the first main portion in the direction away from the electrode assembly. In this way, due to a height difference between the sixth protrusion and the first main portion, when the housing expands along the first direction, the pulling force at the corners is alleviated, thereby further alleviating the compression exerted by the electrode assembly on the corners of the housing, reducing the risk of damage at the corners of the housing, and further improving the reliability of the electrochemical apparatus during use.

In any one or more optional embodiments, a distance between the outer surface of the first main portion and an outer surface of the second bottom wall is T, and a height by which the fifth protrusion protrudes beyond the outer surface of the first main portion is t₁, satisfying: 0.05T≤t₁≤0.4T.

In any one or more optional embodiments, a distance between the outer surface of the first main portion and an outer surface of the second bottom wall is T, and a height by which the sixth protrusion protrudes beyond the outer surface of the first main portion is t₂, satisfying: 0.05T≤t₂≤0.4T.

The above technical solution not only further improves the reliability of the electrochemical apparatus, but also endows the electrochemical apparatus with a relatively high volumetric energy density.

In one or more optional embodiments, the electrode assembly is a wound structure. A winding axis of the wound structure is in the same direction as the second direction. In the electrode assembly that assumes a wound structure, a cut surface of the current collector exists on an end surface of the wound structure. Therefore, when the first sidewall is pressed, the corners of the housing are more prone to damage. By setting the winding axis of the wound structure to be in the same direction as the second direction, the presence of the first protrusion and other similar structures can more favorably improve the reliability of the electrochemical apparatus during use.

A second aspect of this application provides an electrical device. The electrical device includes the electrochemical apparatus disclosed in any one or more embodiments in the first aspect described above. Because the electrochemical apparatus disclosed in the first aspect is at a relatively low risk of damage at the corner positions of the housing during use, the electrical device containing the electrochemical apparatus is of relatively high reliability during use.

### BRIEF DESCRIPTION OF DRAWINGS

To describe the technical solutions in some embodiments of this application more clearly, the following outlines the drawings to be used in the description of the embodiments. Evidently, the drawings outlined below merely illustrate some embodiments of this application, and a person skilled in the art may derive other drawings based on the listed drawings.

FIG. 1 is a schematic perspective view of an electrochemical apparatus according to some embodiments of this application;

FIG. 2 is a cross-sectional view of an electrochemical apparatus according to some embodiments of this application;

FIG. 3 is a cross-sectional view of an electrochemical apparatus according to other embodiments of this application;

FIG. 4 is a schematic perspective view of an electrochemical apparatus according to still other embodiments of this application;

FIG. 5 is a cross-sectional view taken along an A-A line shown in FIG. 4;

FIG. 6 is a cross-sectional view taken along a B-B line shown in FIG. 4; and

FIG. 7 is a cross-sectional view taken along a C-C line shown in FIG. 4.

List of reference signs: 100—electrochemical apparatus; 1001—accommodation space; 101—first sidewall; 1011—first base portion; 10111—outer surface of first base portion; 10112—inner surface of first base portion; 1012—first protrusion; 10121—outer surface of first protrusion; 10122—inner surface of first protrusion; 1013—second protrusion; 10131—outer surface of second protrusion; 10132—inner surface of second protrusion; 102—second sidewall; 1021—outer surface of second sidewall; 103—first bottom wall; 1031—first main portion; 10311—outer surface of first main portion; 10312—inner surface of first main portion; 1032—fifth protrusion; 10321—outer surface of fifth protrusion; 10322—inner surface of fifth protrusion; 1033—sixth protrusion; 10331—outer surface of sixth protrusion; 10332—inner surface of sixth protrusion; 104—second bottom wall; 1041—outer surface of second bottom wall; 105—third sidewall; 1051—third base portion; 10511—outer surface of third base portion; 10512—inner surface of third base portion; 1052—third protrusion; 10521—outer surface of third protrusion; 10522—inner surface of third protrusion; 106—fourth sidewall; 1061—fourth base portion; 10611—outer surface of fourth base portion; 10612—inner surface of fourth base portion; 1062—fourth protrusion; 10621—outer surface of fourth protrusion; 10622—inner surface of fourth protrusion; 20—electrode assembly; 201—tab; 202—electrode plate assembly; 200—first reference plane; 300—second reference plane; X—first direction; Y—second direction; Z—third direction.

### DETAILED DESCRIPTION

The technical solutions of this application are described in detail below with reference to accompanying drawings and specific embodiments. Apparently, the following embodiments are merely intended to more clearly describe the technical solutions of this application, but not intended to limit the protection scope of this application.

Unless otherwise defined, all technical and scientific terms used herein bear the same meanings as what is normally understood by a person skilled in the technical field of this application. The terms used herein are merely intended to describe specific embodiments but not to limit this application. The terms “include” and “contain” and any variations thereof used in the specification and claims of this application are intended as non-exclusive inclusion.

In the description of this application, the terms “first” and “second” are merely intended to distinguish between different items but not intended to indicate or imply relative importance or implicitly specify the number of the indicated technical features, specific order, or order of precedence. In the description of this application, unless otherwise expressly specified, “a plurality of” means two or more.

It is understandable to a person skilled in the art that, to the extent that no conflict occurs, the features in one embodiment described herein may be combined with the features of another embodiment.

In the description of this application, a directional or a positional relationship indicated by the terms such as “center”, “longitudinal”, “transverse”, “length”, “width”, “thickness”, “up”, “down”, “before”, “after”, “left”, “right”, “vertical”, “horizontal”, “top”, “bottom”, “in”, “out”, “clockwise”, “counterclockwise”, “axial”, “radial”, and “circumferential” is a directional or positional relationship based on the illustration in the drawings, and is merely intended for ease or brevity of description of embodiments of this application, but not intended to indicate or imply that the indicated device or component is necessarily located in the specified direction or constructed or operated in the specified direction. Therefore, such terms are not to be understood as a limitation on embodiments of this application.

In the description of this application, unless otherwise expressly specified, the terms such as “mount”, “concatenate”, “connect”, and “fix” are understood in a broad sense. For example, such terms may mean a fixed connection, a detachable connection, or integral formation, and may mean a direct connection or an indirect connection implemented through an intermediary. A person of ordinary skill in the art can understand the specific meanings of the terms in some embodiments of this application according to specific situations.

Currently, electrochemical apparatuses are widely used in the fields such as portable electronic devices, electric vehicles, electric tools, drones, energy storage devices, and VR/AR devices. To meet the demand for a long endurance of electrical devices, the requirements on the energy density of an electrochemical apparatus are increasingly higher. To further increase the energy density, some measures are taken, for example, the coating weight of an active material on the current collector per unit area is increased, or a high-specific-capacity active material is applied (such as a silicon-based material applied to a negative electrode in a lithium-ion battery). However, through research, the applicant hereof finds that for such electrochemical apparatuses, the expansion of the electrode plate increases significantly during charge-discharge cycles. This causes an electrode assembly to press against the corners of the housing, thereby increasing the risk of damage at the corner positions of the housing. In addition, when the housing expands, the corner positions of the housing are subjected to inward pulling forces. This further increases the risk of damage at the corners of the housing under the pressure of the electrode assembly, thereby affecting the reliability of the electrochemical apparatus during use.

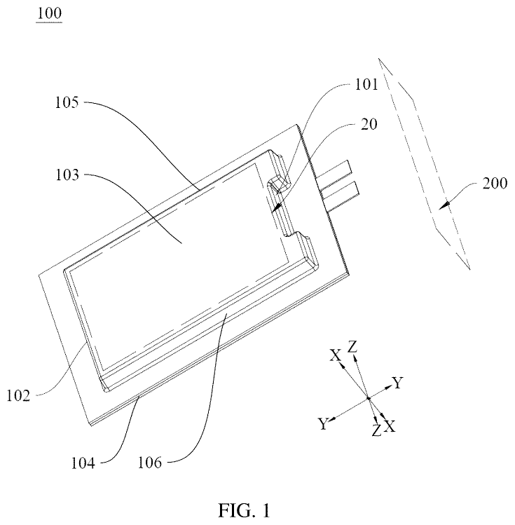

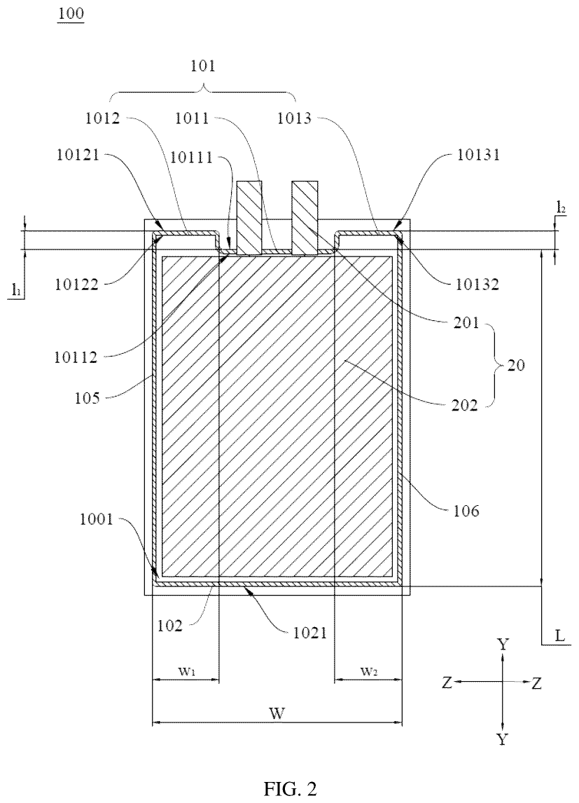

In view of the above situation, referring to FIG. 1 and FIG. 2, a first aspect of this application provides an electrochemical apparatus 100. The electrochemical apparatus 100 includes an electrode assembly 20 and a housing. The housing includes a first bottom wall 103 and a second bottom wall 104 disposed opposite to each other along a first direction X, a first sidewall 101 and a second sidewall 102 disposed opposite to each other along a second direction Y, and a third sidewall 105 and a fourth sidewall 106 disposed opposite to each other along a third direction Z. The first direction X is a thickness direction of the electrode assembly 20. The first direction X, the second direction Y, and the third direction Z are perpendicular to each other. The first sidewall 101, the second sidewall 102, the third sidewall 105, the fourth sidewall 106, the first bottom wall 103, and the second bottom wall 104 jointly enclose and define an accommodation space 1001. The electrode assembly 20 is accommodated in the accommodation space 1001. The first sidewall 101 includes a first base portion 1011 and a first protrusion 1012. The first protrusion 1012 connects the first base portion 1011 and the third sidewall 105. An outer surface 10121 of the first protrusion protrudes beyond an outer surface 10111 of the first base portion along the second direction Y. An inner surface 10122 of the first protrusion is recessed relative to an inner surface 10112 of the first base portion in a direction away from the electrode assembly 20. In the electrochemical apparatus 100 of this application, by providing the first protrusion 1012 on the first sidewall 101, this application makes the corner positions of the electrode assembly less prone to hit the first sidewall 101 when the electrode assembly 20 expands. In addition, due to a height difference between the first protrusion 1012 and the first base portion 1011, when the housing expands along the first direction X, the first bottom wall 103 and/or the second bottom wall 104 pulls the first sidewall 101, causing the first sidewall 101 to collapse and deform. In this process, the electrode assembly 20 first contacts the first base portion 1011 to form a support, thereby alleviating the compression exerted by the electrode assembly 20 on the corners of the housing, reducing the risk of damage at the corners of the housing, and improving the reliability of the electrochemical apparatus during use.

In some embodiments, the electrode assembly 20 includes a tab 201 and an electrode plate assembly 202. The electrode plate assembly 202 is accommodated in the accommodation space 1001 of the housing. One end of the tab 201 is electrically connected to the electrode plate assembly 202, and the other end of the tab 201 extends out of the housing. The electrode plate assembly 202 typically includes a positive electrode plate, a separator, and a negative electrode plate. The separator is disposed between the positive electrode plate and the negative electrode plate. In some embodiments, the positive electrode plate includes a positive current collector and a positive active material layer. The positive active material layer is applied to a surface of the positive current collector. The tab 201 includes a positive tab. The positive tab is connected to the positive current collector. The negative electrode plate includes a negative current collector and a negative active material layer. The negative active material layer is applied to a surface of the negative current collector. The tab 201 includes a negative tab. The negative tab is connected to the negative current collector. Taking a lithium-ion battery as an example, the positive current collector may be aluminum foil, and the positive active material may include at least one of lithium cobalt oxide, lithium iron phosphate, lithium manganese iron phosphate, lithium nickel cobalt manganese oxide, lithium nickel cobalt aluminum oxide, lithium manganese oxide, or the like; and the negative current collector may be copper foil, and the negative active material may include at least one of a carbon material, a silicon-based material, or the like. In some embodiments, the tab 201 may be integrally formed with the current collector. In other embodiments, the tab 201 and the electrode plate may be separately formed, and the tab 201 is electrically connected to the current collector of the electrode plate by riveting, welding, or other means. In some embodiments, the structure of the electrode assembly 20 may include, but is not limited to, a wound structure, a stacked structure, or the like.

As used hereinafter, the term “out” refers to the side facing away from the accommodation space 1001, and term “in” refers to the side facing the accommodation space 1001.

The housing may be made of a material such as aluminum laminated film, steel, or aluminum, without being limited herein. The housing typically includes a plurality of wall portions. The plurality of wall portions jointly define an accommodation space 1001. In some embodiments, the housing may include a first part and a second part. The first part and the second part are sealed together to form the accommodation space 1001. Of the first part and the second part, one may be provided with an opening, or both may be provided with an opening. The structure of the first part may be the same as or different from that of the second part. For example, a groove may be provided in the first part, and the groove opening is the opening of the first part. The electrode assembly 20 may be mounted into the groove through the groove opening. The second part may be in the shape of a flat plate. The second part closes the groove opening to form a closed accommodation space 1001. For example, grooves may be provided in both the first part and the second part. After the two grooves fit with each other and after the first part and the second part are sealed, the two grooves jointly define a closed accommodation space 1001.

In some embodiments, referring to FIG. 1 and FIG. 2, a first groove for accommodating the electrode assembly 20 may be provided in the first part of the housing. In the first direction X, the first groove includes a first bottom wall 103. In the second direction Y, the first groove includes a first sidewall 101 and a second sidewall 102 that are opposite to each other. In the third direction Z, the first groove includes a third sidewall 105 and a fourth sidewall 106 that are opposite to each other. The second part of the housing closes the first groove to form an accommodation space 1001. In the first direction X, the second part includes a second bottom wall 104 opposite to the first bottom wall 103. The first protrusion 1012 may be formed along with the first groove when the first groove is being processed. This design achieves high processing efficiency and cost-effectiveness. In other embodiments, the second part may be provided with a second groove corresponding to the first groove.

The first sidewall 101 includes a first base portion 1011 and a first protrusion 1012, and the first protrusion 1012 connects the first base portion 1011 and the third sidewall 105. This arrangement means that the first protrusion 1012 is disposed at the corner formed by the third sidewall 105 and the first sidewall 101 of the housing. In others words, an orthographic projection of the first protrusion 1012 on the first reference plane 200 is located at a first end of an orthographic projection of the first sidewall 101 on the first reference plane 200 along the third direction Z, where the first reference plane 200 is perpendicular to the second direction Y. The corner position of the electrode assembly 20 corresponds to the corner of the housing. The corner is generally understood as a location at which at least three wall portions of the housing intersect each other to define the accommodation space 1001. The shape of the electrode assembly 20 may be understood as a reference body containing a plurality of surfaces. Taking a stacked-type electrode assembly 20 as an example, the electrode assembly 20 may include a top surface and a bottom surface disposed opposite to each other along the stacking direction of electrode plates, and side surfaces disposed peripherally at the edges of the top surface and connecting the edges of the bottom surface. The corner position of the electrode assembly 20 may refer to a corner position of a projection of the electrode assembly 20 along the stacking direction of electrode plates. Taking a stacked-type electrode assembly 20 as an example, the electrode assembly 20 may include an outer peripheral surface as well as a top surface and a bottom surface disposed opposite to each other along a winding axis direction. Both the top surface and the bottom surface are connected to the edges of the outer peripheral surface. The corner position of the electrode assembly 20 may refer to the corner position of the projection of the electrode assembly 20 along the thickness direction thereof. The projection of the first protrusion 1012 on the first reference plane 200 along the second direction Y at least partially overlaps the projection of the corner position of the electrode assembly 20 on the first reference plane 200.

According to some embodiments of this application, referring to FIG. 1 and FIG. 2, the first sidewall 101 further includes a second protrusion 1013. The second protrusion 1013 connects the first base portion 1011 and the fourth sidewall 106. An outer surface 10131 of the second protrusion protrudes beyond an outer surface 10111 of the first base portion along the second direction Y. An inner surface 10132 of the second protrusion is recessed relative to an inner surface 10112 of the first base portion in a direction away from the electrode assembly 20. The second protrusion 1013 connects the first base portion 1011 and the fourth sidewall 106. This arrangement means that the second protrusion 1013 is disposed at the corner formed by the fourth sidewall 106 and the first sidewall 101 of the housing. In others words, an orthographic projection of the second protrusion 1013 on the first reference plane 200 is located at a second end of the orthographic projection of the first sidewall 101 on the first reference plane 200 along the third direction Z, where the second end is opposite to the first end. In this way, the first sidewall 101 includes the first protrusion 1012 and the second protrusion 1013, thereby further reducing the risk of damage at the corners on both sides of the housing, and improving the reliability of the electrochemical apparatus 100 during use. The dimensions of the second protrusion 1013 may be the same as or different from the dimensions of the first protrusion 1012.

According to some embodiments of this application, referring to FIG. 1 and FIG. 2, along the second direction Y, a distance between the outer surface 10111 of the first base portion and an outer surface 1021 of the second sidewall is L, and a height by which the first protrusion 1012 protrudes beyond the outer surface 10111 of the first base portion is l₁, satisfying: 0.005L≤l₁≤0.1L. The height l₁ by which the first protrusion 1012 protrudes beyond the outer surface 10111 of the first base portion may be 0.005L, 0.006L, 0.007L, 0.008L, 0.009L, 0.01L, 0.015L, 0.02L, 0.04L, 0.05L, 0.06L, 0.08L, 0.1L, or a value falling within a range formed by any two thereof.

According to some embodiments of this application, still referring to FIG. 1 and FIG. 2, along the third direction Z, a distance between an outer surface of the third sidewall 105 and an outer surface of the fourth sidewall 106 is W, and a width of the first protrusion 1012 is w₁, satisfying: 0.05W≤w₁≤0.3W. The width w₁ of the first protrusion 1012 may be 0.05W, 0.06W, 0.07W, 0.08W, 0.09W, 0.1W, 0.11W, 0.12W, 0.13W, 0.14W, 0.15W, 0.16W, 0.17W, 0.18W, 0.19W, 0.2W, 0.21W, 0.22W, 0.23W, 0.24W, 0.25W, 0.26W, 0.27W, 0.28W, 0.29W, 0.3W, or a value falling within a range formed by any two thereof.

In the above technical solution, the first protrusion 1012 satisfies 0.005L≤l₁≤0.1L in the second direction Y, and/or satisfies 0.05W≤w₁≤0.3W in the third direction Z. This design not only improves the reliability of the electrochemical apparatus 100, but also endows the electrochemical apparatus 100 with a relatively high volumetric energy density.

According to some embodiments of this application, referring to FIG. 1 and FIG. 2, along the second direction Y, a distance between the outer surface 10111 of the first base portion and an outer surface 1021 of the second sidewall is L, and a height by which the second protrusion 1013 protrudes beyond the outer surface 10111 of the first base portion is l₂, satisfying: 0.005L≤l₂≤0.1L. The height 12 by which the second protrusion 1013 protrudes beyond the outer surface 10111 of the first base portion may be 0.005L, 0.006L, 0.007L, 0.008L, 0.009L, 0.01L, 0.015L, 0.02L, 0.04L, 0.05L, 0.06L, 0.08L, 0.1L, or a value falling within a range formed by any two thereof.

According to some embodiments of this application, referring to FIG. 1 and FIG. 2, along the third direction Z, a distance between an outer surface of the third sidewall 105 and an outer surface of the fourth sidewall 106 is W, and a width of the second protrusion 1013 is w₂, satisfying: 0.05W≤w₂≤0.3W. The width w₂ of the second protrusion 1013 may be 0.05W, 0.06W, 0.07W, 0.08W, 0.09W, 0.1W, 0.11W, 0.12W, 0.13W, 0.14W, 0.15W, 0.16W, 0.17W, 0.18W, 0.19W, 0.2W, 0.21W, 0.22W, 0.23W, 0.24W, 0.25W, 0.26W, 0.27W, 0.28W, 0.29W, 0.3W, or a value falling within a range formed by any two thereof.

In the above technical solution, the second protrusion 1013 satisfies 0.005L≤l₂≤0.1L in the second direction Y, and/or satisfies 0.05W≤w₂≤0.3W in the third direction Z. This design not only further improves the reliability of the electrochemical apparatus 100, but also endows the electrochemical apparatus 100 with a relatively high volumetric energy density.

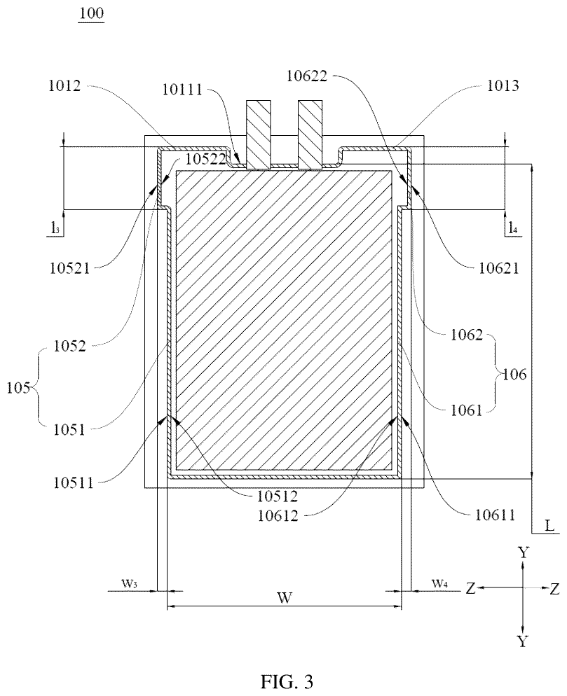

According to some embodiments of this application, referring to FIG. 3, the third sidewall 105 includes a third base portion 1051 and a third protrusion 1052. The third protrusion 1052 connects the third base portion 1051 and the first protrusion 1012. An outer surface 10521 of the third protrusion protrudes beyond an outer surface 10511 of the third base portion along the third direction Z. An inner surface 10522 of the third protrusion is recessed relative to an inner surface 10512 of the third base portion in a direction away from the electrode assembly 20. That the third protrusion 1052 connects the third base portion 1051 and the first protrusion 1012 means that the third protrusion 1052 is also located at a corner of the housing. In this way, by providing the third protrusion 1052 on the third sidewall 105, this application makes corner positions of the electrode assembly less prone to hit the third sidewall 105 when the electrode assembly 20 expands. In addition, due to a height difference between the third protrusion 1052 and the third base portion 1051, when the housing expands along the first direction X, the first bottom wall 103 and/or the second bottom wall 104 pulls the third sidewall 105, causing the third sidewall 105 to collapse and deform. In this process, the electrode assembly 20 first contacts the third base portion 1051 to form a support, thereby further alleviating the compression exerted by the electrode assembly 20 on the corners of the housing, reducing the risk of damage at the corners of the housing, and further improving the reliability of the electrochemical apparatus 100 during use.

According to some embodiments of this application, still referring to FIG. 3, the fourth sidewall 106 includes a fourth base portion 1061 and a fourth protrusion 1062. The fourth protrusion 1062 connects the fourth base portion 1061 and the second protrusion 1013. An outer surface 10621 of the fourth protrusion protrudes beyond an outer surface 10611 of the fourth base portion along the third direction Z. An inner surface 10622 of the fourth protrusion is recessed relative to an inner surface 10612 of the fourth base portion in a direction away from the electrode assembly 20. That the fourth protrusion 1062 connects the fourth base portion 1061 and the second protrusion 1013 means that the fourth protrusion 1062 is also located at a corner of the housing. In this way, by providing the fourth protrusion 1062 on the fourth sidewall 106, this application makes corner positions of the electrode assembly less prone to hit the fourth sidewall 106 when the electrode assembly 20 expands. In addition, due to a height difference between the fourth protrusion 1062 and the fourth base portion 1061, when the housing expands along the first direction X, the first bottom wall 103 and/or the second bottom wall 104 pulls the fourth sidewall 106, causing the fourth sidewall 106 to collapse and deform. In this process, the electrode assembly 20 first contacts the fourth base portion 1061 to form a support, thereby further alleviating the compression exerted by the electrode assembly 20 on the corners of the housing, reducing the risk of damage at the corners of the housing, and further improving the reliability of the electrochemical apparatus 100 during use.

According to some embodiments of this application, referring to FIG. 3, along the third direction Z, a distance between the outer surface 10511 of the third base portion and an outer surface of the fourth sidewall 106 is W, and a height by which the third protrusion 1052 protrudes beyond the outer surface 10511 of the third base portion is w₃, satisfying: 0.05W≤w₃≤0.3W. The height w₃ by which the third protrusion 1052 protrudes beyond the outer surface 10511 of the third base portion may be 0.05W, 0.06W, 0.07W, 0.08W, 0.09W, 0.1W, 0.11W, 0.12W, 0.13W, 0.14W, 0.15W, 0.16W, 0.17W, 0.18W, 0.19W, 0.2W, 0.21W, 0.22W, 0.23W, 0.24W, 0.25W, 0.26W, 0.27W, 0.28W, 0.29W, 0.3W, or a value falling within a range formed by any two thereof.

According to some embodiments of this application, referring to FIG. 3, along the second direction Y, a distance between the outer surface 10111 of the first base portion and an outer surface 1021 of the second sidewall is L, and a width of the third protrusion 1052 is 13, satisfying: 0.005L≤l₃≤0.1L. The width 13 of the third protrusion 1052 may be 0.005L, 0.006L, 0.007L, 0.008L, 0.009L, 0.01L, 0.015L, 0.02L, 0.04L, 0.05L, 0.06L, 0.08L, 0.1L, or a value falling within a range formed by any two thereof.

According to some embodiments of this application, referring to FIG. 3, along the third direction Z, a distance between the outer surface 10611 of the fourth base portion and an outer surface of the third sidewall 105 is W, and a height by which the fourth protrusion 1062 protrudes beyond the outer surface of the fourth base portion 1061 is w₄, satisfying: 0.05W≤w₄≤0.3W. The height w₄ by which the fourth protrusion 1062 protrudes beyond the outer surface of the fourth base portion 1061 may be 0.05W, 0.06W, 0.07W, 0.08W, 0.09W, 0.1W, 0.11W, 0.12W, 0.13W, 0.14W, 0.15W, 0.16W, 0.17W, 0.18W, 0.19W, 0.2W, 0.21W, 0.22W, 0.23W, 0.24W, 0.25W, 0.26W, 0.27W, 0.28W, 0.29W, 0.3W, or a value falling within a range formed by any two thereof.

According to some embodiments of this application, referring to FIG. 3, along the second direction Y, a distance between the outer surface 10111 of the first base portion and an outer surface 1021 of the second sidewall is L, and a width of the fourth protrusion 1062 is l₄, satisfying: 0.005L≤l₄≤0.1L. The width 14 of the fourth protrusion 1062 may be 0.005L, 0.006L, 0.007L, 0.008L, 0.009L, 0.01L, 0.015L, 0.02L, 0.04L, 0.05L, 0.06L, 0.08L, 0.1L, or a value falling within a range formed by any two thereof.

In the above technical solution, the third protrusion 1052 satisfies 0.05W≤w₃≤0.3W in the third direction Z, and/or, the third protrusion 1052 satisfies 0.005L≤l₃≤0.1L in the second direction Y, and/or, the fourth protrusion 1062 satisfies 0.05W≤w₄≤0.3W in the third direction Z, and/or, the fourth protrusion 1062 satisfies 0.005L≤l₄≤0.1L in the second direction Y. This design not only further improves the reliability of the electrochemical apparatus 100, but also endows the electrochemical apparatus 100 with a relatively high volumetric energy density.

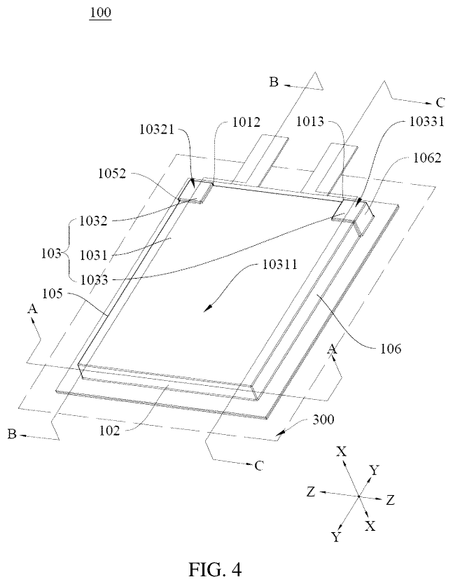

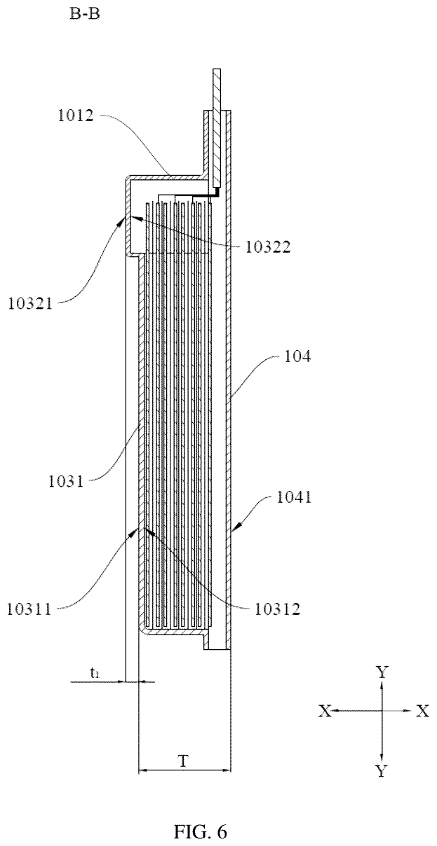

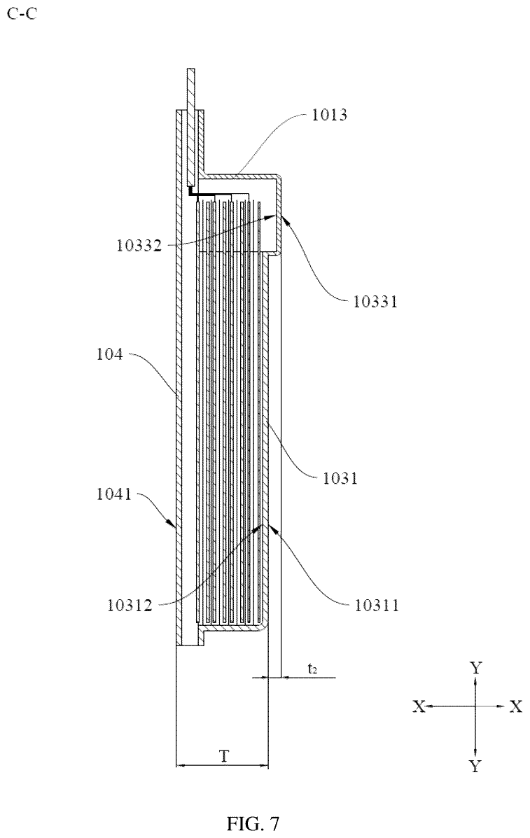

According to some embodiments of this application, referring to FIG. 4, FIG. 6, and FIG. 7, the first bottom wall 103 includes a first main portion 1031 and a fifth protrusion 1032. The fifth protrusion 1032 is located in a corner region of the first bottom wall 103. The fifth protrusion 1032 connects the first protrusion 1012 and the third protrusion 1052. The outer surface 10321 of the fifth protrusion protrudes beyond the outer surface 10311 of the first main portion along the first direction X. The inner surface 10322 of the fifth protrusion is recessed relative to the inner surface 10312 of the first main portion in a direction away from the electrode assembly 20. In this way, due to a height difference between the fifth protrusion 1032 and the first main portion 1031, when the housing expands along the first direction X, the pulling force at the corners is alleviated, thereby further alleviating the compression exerted by the electrode assembly 20 on the corners of the housing, reducing the risk of damage at the corners of the housing, and further improving the reliability of the electrochemical apparatus 100 during use. The fifth protrusion 1032 is located in the corner region of the first bottom wall 103. The corner region of the first bottom wall 103 may be understood as a region near an intersection of two edges of an orthographic projection of the first bottom wall 103 on the second reference plane 300. The second reference plane 300 is perpendicular to the first direction X. The corner is generally understood as a location at which at least three wall portions of the housing intersect each other to define the accommodation space 1001. The orthographic projection of the fifth protrusion 1032 on the second reference plane 300 along the first direction X at least partially overlaps the orthographic projection of the corner position of the electrode assembly 20 on the second reference plane 300.

According to some embodiments of this application, referring to FIG. 4, FIG. 6, and FIG. 7, the first bottom wall 103 includes a first main portion 1031 and a sixth protrusion 1033. The sixth protrusion 1033 is located in a corner region of the first bottom wall 103. The sixth protrusion 1033 connects the second protrusion 1013 and the fourth protrusion 1062. The outer surface 10331 of the sixth protrusion protrudes beyond the outer surface 10311 of the first main portion along the first direction X. The inner surface 10332 of the sixth protrusion is recessed relative to the inner surface 10312 of the first main portion in a direction away from the electrode assembly 20. In this way, due to a height difference between the sixth protrusion 1033 and the first main portion 1031, when the housing expands along the first direction X, the pulling force at the corners is alleviated, thereby further alleviating the compression exerted by the electrode assembly 20 on the corners of the housing, reducing the risk of damage at the corners of the housing, and further improving the reliability of the electrochemical apparatus 100 during use. The orthographic projection of the sixth protrusion 1033 on the second reference plane 300 along the first direction X at least partially overlaps the orthographic projection of the corner position of the electrode assembly 20 on the second reference plane 300.

In some embodiments, the first bottom wall 103 includes a first main portion 1031, a fifth protrusion 1032, and a sixth protrusion 1033. The fifth protrusion 1032 and the sixth protrusion 1033 are disposed opposite to each other along the third direction Z, or in other words, the fifth protrusion 1032 and the sixth protrusion 1033 are located at two adjacent corner positions of the first bottom wall 103 along the third direction Z.

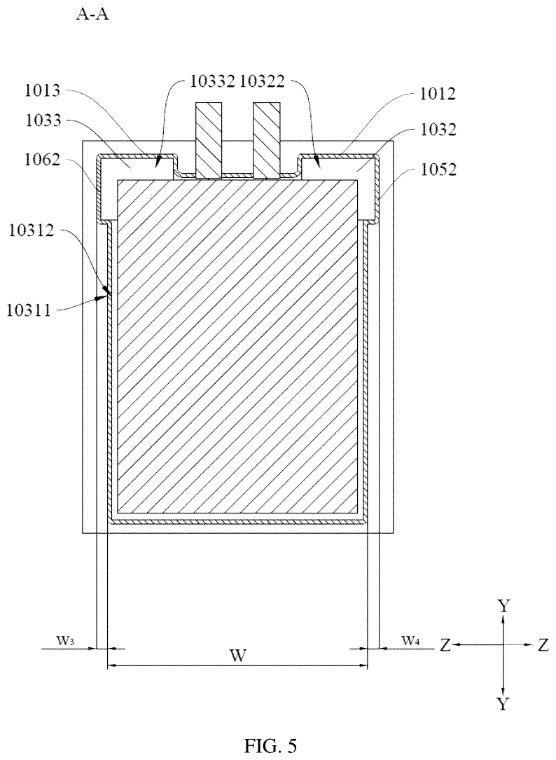

According to some embodiments of this application, referring to FIG. 4 to FIG. 7, a distance between the outer surface 10311 of the first main portion and an outer surface 1041 of the second bottom wall is T, and a height by which the fifth protrusion 1032 protrudes beyond the outer surface 10311 of the first main portion is t₁, satisfying: 0.05T≤t₁≤0.4T. The height t₁ by which the fifth protrusion 1032 protrudes beyond the outer surface 10311 of the first main portion may be 0.05T, 0.06T, 0.07T, 0.08T, 0.09T, 0.1T, 0.2T, 0.3T, 0.4T, or a value falling within a range formed by any two thereof.

According to some embodiments of this application, a height by which the sixth protrusion 1033 protrudes beyond the outer surface 10311 of the first main portion is t₂, satisfying: 0.05T≤t₂≤0.4T. The height t₂ by which the fifth protrusion 1032 protrudes beyond the outer surface 10311 of the first main portion may be 0.05T, 0.06T, 0.07T, 0.08T, 0.09T, 0.1T, 0.2T, 0.3T, 0.4T, or a value falling within a range formed by any two thereof.

In the above technical solution, the fifth protrusion 1032 satisfies 0.05T≤t₁≤0.4T in the first direction X, and/or, the sixth protrusion 1033 satisfies 0.05T≤t₂≤0.4T in the first direction X. This design not only further improves the reliability of the electrochemical apparatus 100, but also endows the electrochemical apparatus 100 with a relatively high volumetric energy density.

According to some embodiments of this application, referring to FIG. 1 to FIG. 7, the electrode assembly 20 is a wound structure. The winding axis of the wound structure is in the same direction as the second direction Y. In the electrode assembly 20 that assumes a wound structure, a cut surface of the current collector exists on an end surface of the wound structure. Therefore, when the first sidewall 101 is pressed, the corners of the housing are more prone to damage. By setting the winding axis of the wound structure to be in the same direction as the second direction Y, the presence of the first protrusion 1012 and other similar structures can more favorably improve the reliability of the electrochemical apparatus 100 during use.

Depending on the assembling environment of the electrochemical apparatus 100 in the electrical device, the shape of the electrochemical apparatus 100 may be rectangular, square, triangular, trapezoidal, L-shaped, T-shaped, or the like. The electrochemical apparatus of this application may be, but is not limited to, a lithium-ion battery, a sodium-ion battery, a magnesium-ion battery, or the like.

The following describes the technical solution of this application in more detail using a lithium-ion battery as an example.

### Embodiment 1

Preparation of a positive electrode plate: Mixing lithium cobalt oxide as a positive active material, Super P as a conductive agent, and polyvinylidene fluoride as a binder at a mass ratio of 97.5:1:1.5. Adding N-methyl-pyrrolidone (NMP), and stirring well with a vacuum mixer to obtain a positive electrode slurry. Coating a positive current collector aluminum foil with the positive electrode slurry evenly, oven-drying the foil, and then performing cold-pressing, cutting, and slitting to obtain a positive electrode plate.

Preparation of a negative electrode plate: Mixing artificial graphite as a negative active material, sodium carboxymethyl cellulose (CMC) as a thickener, and styrene-butadiene rubber (SBR) as a binder at a mass ratio of 96:1.5:2.5. Adding deionized water, and stirring well with a vacuum mixer to obtain a negative electrode slurry. Coating negative current collector copper foil with the negative electrode slurry evenly, oven-drying the foil, and performing cold-pressing, cutting, and slitting to obtain a negative electrode plate.

Preparation of an electrolyte solution: Mixing ethylene carbonate (EC), ethyl methyl carbonate (EMC), and diethyl carbonate (DEC) in a dry argon atmosphere glovebox at a mass ratio of 3:5:2. Adding a lithium salt LiPF₆, and stirring well to obtain an electrolyte solution in which the mass percentage of LiPF₆ is 12.5%.

Preparation of a separator: Mixing aluminum oxide and polyvinylidene fluoride evenly at a mass ratio of 95:5 in deionized water to form a ceramic coating slurry, and dispersing polyvinylidene fluoride in the deionized water, and mixing well to form an adhesive coating slurry. Subsequently, applying the ceramic coating slurry uniformly onto one surface of a polyethylene porous substrate using a micro-gravure coating method. Drying the slurry, and then applying the adhesive coating slurry onto the ceramic coating surface and the other surface of the polyethylene porous substrate by spraying, and drying the slurry to obtain the desired separator.

Preparation of a lithium-ion battery: Stacking the positive electrode plate, the separator, and the negative electrode plate sequentially such that the separator is located between the positive electrode plate and the negative electrode plate to serve as an isolation function. Winding the stacked structure to obtain a jelly-roll electrode assembly. Welding tabs 201 to the electrode assembly, and then placing the electrode assembly 20 into an outer-packaging aluminum laminated film with a recess stamped on one side. Forming a first protrusion 1012 and a second protrusion 1013 at the two ends of the first sidewall 101 during the stamping. Leading out the tabs 201 from a side on which the first sidewall 101 is located. Sealing the outer packaging preliminarily, and then injecting the above-prepared electrolyte solution. Performing steps such as vacuum sealing, standing, formation, shaping, and capacity testing to obtain a lithium-ion battery. The lithium-ion battery is 87 mm long (L), 64 mm wide (W), and 4.8 mm thick (T). The height l₁ by which the first protrusion 1012 protrudes beyond the outer surface 10111 of the first base portion and the height 12 by which the second protrusion 1013 protrudes beyond the outer surface 10111 of the first base portion are 0.005L. The width w₁ of the first protrusion 1012 and the width w₂ of the second protrusion 1013 are 0.1W.

Embodiments 2 to 8: different from Embodiment 1 only in that the height l₁ by which the first protrusion 1012 protrudes beyond the outer surface 10111 of the first base portion and the height 12 by which the second protrusion 1013 protrudes beyond the outer surface 10111 of the first base portion are adjusted according to the ratios specified in Table 1.

Embodiments 9 to 11: different from Embodiment 2 only in that the width w₁ of the first protrusion 1012 and the width w₂ of the second protrusion 1013 are adjusted according to the ratios specified in Table 1.

Comparative Embodiment 1: different from Embodiment 1 in that neither the first protrusion 1012 nor the second protrusion 1013 is disposed.

Cycling damage test: performing the test at a temperature of 35° C. in groups, where each group contains 10 lithium-ion batteries. Leaving the lithium-ion batteries to stand for 60 minutes in 35° C. constant-temperature environment such that the lithium-ion batteries reach a constant-temperature state. Subsequently, charging the batteries at a constant current of 1 C until the voltage reaches 4.48 V, and then charging the batteries at a constant voltage of 4.48 V until the current tapers off to 0.05 C, and then leaving the batteries to stand for 5 minutes. Next, discharging the batteries at a constant current of 0.7 C until the voltage drops to 3 V, and leaving the batteries to stand for 5 minutes, thereby completing one charge-discharge cycle. Repeating the above charge-discharge operations for 500 cycles, and then checking the corner positions of the lithium-ion batteries for damage or leakage. Counting the number of damaged or leaking lithium-ion batteries.

The specific parameters and the cycling damage test results of lithium-ion batteries in each embodiment and comparative embodiment are shown in Table 1.

TABLE 1
Specific parameters and cycling damage test results of lithium-
ion batteries in embodiments and comparative embodiments

| | Height (l₁ or l₂) by which | Width (w₁) of first | | Number of |
|---|---|---|---|---|
| | first or second protrusion | protrusion or width | Number of | damaged |
| | protrudes beyond outer | (w₂) of second | tested | samples during |
| | surface of first base portion | protrusion | samples | cycling |
| Comparative | / | / | 10 | 4 |
| Embodiment | | | | |
| Embodiment 1 | 0.005 L | 0.1 W | 10 | 1 |
| Embodiment 2 | 0.01 L | 0.1 W | 10 | 0 |
| Embodiment 3 | 0.015 L | 0.1 W | 10 | 0 |
| Embodiment 4 | 0.02 L | 0.1 W | 10 | 0 |
| Embodiment 5 | 0.025 L | 0.1 W | 10 | 0 |
| Embodiment 6 | 0.03 L | 0.1 W | 10 | 0 |
| Embodiment 7 | 0.035 L | 0.1 W | 10 | 0 |
| Embodiment 8 | 0.04 L | 0.1 W | 10 | 0 |
| Embodiment 9 | 0.01 L | 0.05 W | 10 | 1 |
| Embodiment 10 | 0.01 L | 0.15 W | 10 | 0 |
| Embodiment 11 | 0.01 L | 0.2 W | 10 | 0 |

As can be seen from Table 1, the probability of damage to the lithium-ion batteries in Embodiments 1 to 11 during cycling is reduced. Therefore, the first protrusion 1012 and the second protrusion 1013 provided can improve the reliability of the electrochemical apparatus 100 during use.

A second aspect of this application further provides an electrical device. The electrical device includes the electrochemical apparatus 100 disclosed in one or more embodiments described above. In the above technical solutions, because the electrochemical apparatus 100 disclosed in an embodiment in the first aspect is at a relatively low risk of damage at the corners of the housing during use, the electrical device containing the electrochemical apparatus 100 is of relatively high reliability during use. The electrical device of this application may be, but is not limited to, a portable electronic device, an electric vehicle, an electric tool, a drone, an energy storage device, or a VR/AR device.

Finally, it is noted that the above embodiments are merely intended to describe the technical solutions of this application but not to limit this application. Although this application has been described in detail with reference to the foregoing embodiments, a person of ordinary skill in the art understands that modifications may still be made to the technical solutions described in the foregoing embodiments, or equivalent replacements may still be made to some or all technical features in the technical solutions. Such modifications and equivalent replacements fall within the scope of the claims and specification hereof without making the essence of the corresponding technical solutions depart from the scope of the technical solutions of the embodiments of this application. Particularly, to the extent that no structural conflict exists, various technical features mentioned in different embodiments may be combined in any manner.

What is claimed is:

1. An electrochemical apparatus, comprising:
an electrode assembly; and
a housing, comprising a first bottom wall and a second bottom wall disposed opposite to each other along a first direction, a first sidewall and a second sidewall disposed opposite to each other along a second direction, and a third sidewall and a fourth sidewall disposed opposite to each other along a third direction, wherein the first direction is a thickness direction of the electrode assembly; the first direction, the second direction, and the third direction are perpendicular to each other; and the electrode assembly is accommodated in the housing, wherein
the first sidewall comprises a first base portion and a first protrusion, the first protrusion connects the first base portion and the third sidewall, an outer surface of the first protrusion protrudes beyond an outer surface of the first base portion along the second direction, and an inner surface of the first protrusion is recessed relative to an inner surface of the first base portion in a direction away from the electrode assembly.

2. The electrochemical apparatus according to claim 1, wherein the first sidewall further comprises a second protrusion, the second protrusion connects the first base portion and the fourth sidewall, an outer surface of the second protrusion protrudes beyond the outer surface of the first base portion along the second direction, and an inner surface of the second protrusion is recessed relative to the inner surface of the first base portion in the direction away from the electrode assembly.

3. The electrochemical apparatus according to claim 1, wherein the electrochemical apparatus satisfies at least one of the following conditions:
(1) along the second direction, a distance between the outer surface of the first base portion and an outer surface of the second sidewall is L, and a height by which the first protrusion protrudes beyond the outer surface of the first base portion is l₁, wherein 0.005L≤l₁≤0.1L; or
(2) along the third direction, a distance between an outer surface of the third sidewall and an outer surface of the fourth sidewall is W, and a width of the first protrusion is w₁, wherein 0.05W≤w₁≤0.3W.

4. The electrochemical apparatus according to claim 2, wherein the electrochemical apparatus satisfies at least one of the following conditions:
(1) along the second direction, a distance between the outer surface of the first base portion and an outer surface of the second sidewall is L, and a height by which the second protrusion protrudes beyond the outer surface of the first base portion is l₂, wherein 0.005L≤l₂≤0.1L; or
(2) along the third direction, a distance between an outer surface of the third sidewall and an outer surface of the fourth sidewall is W, and a width of the second protrusion is w₂, wherein 0.05W≤w₂≤0.3W.

5. The electrochemical apparatus according to claim 2, wherein the electrochemical apparatus satisfies at least one of the following conditions:
(1) the third sidewall comprises a third base portion and a third protrusion, the third protrusion connects the third base portion and the first protrusion, an outer surface of the third protrusion protrudes beyond an outer surface of the third base portion along the third direction, and an inner surface of the third protrusion is recessed relative to an inner surface of the third base portion in the direction away from the electrode assembly; or
(2) the fourth sidewall comprises a fourth base portion and a fourth protrusion, the fourth protrusion connects the fourth base portion and the second protrusion, an outer surface of the fourth protrusion protrudes beyond an outer surface of the fourth base portion along the third direction, and an inner surface of the fourth protrusion is recessed relative to an inner surface of the fourth base portion in the direction away from the electrode assembly.

6. The electrochemical apparatus according to claim 5, wherein the electrochemical apparatus satisfies at least one of the following conditions:
(1) along the third direction, a distance between the outer surface of the third base portion and an outer surface of the fourth sidewall is W, and a height by which the third protrusion protrudes beyond the outer surface of the third base portion is w₃, wherein 0.05W≤w₃≤0.3W; or
(2) along the second direction, a distance between the outer surface of the first base portion and an outer surface of the second sidewall is L, and a width of the third protrusion is l₃, wherein 0.005L≤l₃≤0.1L;
(3) along the third direction, a distance between the outer surface of the fourth base portion and an outer surface of the third sidewall is W, and a height by which the fourth protrusion protrudes beyond the outer surface of the fourth base portion is w₄, wherein 0.05W≤w₄≤0.3W; or
(4) along the second direction, a distance between the outer surface of the first base portion and an outer surface of the second sidewall is L, and a width of the fourth protrusion is l₄, wherein 0.005L≤l₄≤0.1L.

7. The electrochemical apparatus according to claim 5, wherein the electrochemical apparatus satisfies at least one of the following conditions:
(1) the first bottom wall comprises a first main portion and a fifth protrusion, the fifth protrusion is located in a corner region of the first bottom wall, the fifth protrusion connects the first protrusion and the third protrusion, an outer surface of the fifth protrusion protrudes beyond an outer surface of the first main portion along the first direction, and an inner surface of the fifth protrusion is recessed relative to an inner surface of the first main portion in the direction away from the electrode assembly; or
(2) the first bottom wall comprises a first main portion and a sixth protrusion, the sixth protrusion is located in a corner region of the first bottom wall, the sixth protrusion connects the second protrusion and the fourth protrusion, an outer surface of the sixth protrusion protrudes beyond an outer surface of the first main portion along the first direction, and an inner surface of the sixth protrusion is recessed relative to an inner surface of the first main portion in the direction away from the electrode assembly.

8. The electrochemical apparatus according to claim 7, wherein a distance between the outer surface of the first main portion and an outer surface of the second bottom wall is T, and the electrochemical apparatus satisfies at least one of the following conditions:
(1) a height by which the fifth protrusion protrudes beyond the outer surface of the first main portion is t₁, wherein 0.05T≤t₁≤0.4T; or
(2) a height by which the sixth protrusion protrudes beyond the outer surface of the first main portion is t₂, wherein 0.05T≤t₂≤0.4T.

9. The electrochemical apparatus according to claim 1, wherein the electrode assembly is a wound structure, and a winding axis of the wound structure is in the same direction as the second direction.

10. An electrical device, comprising an electrochemical apparatus, the electrochemical apparatus comprises:
an electrode assembly; and
a housing, comprising a first bottom wall and a second bottom wall disposed opposite to each other along a first direction, a first sidewall and a second sidewall disposed opposite to each other along a second direction, and a third sidewall and a fourth sidewall disposed opposite to each other along a third direction, wherein the first direction is a thickness direction of the electrode assembly; the first direction, the second direction, and the third direction are perpendicular to each other; and the electrode assembly is accommodated in the housing, wherein
the first sidewall comprises a first base portion and a first protrusion, the first protrusion connects the first base portion and the third sidewall, an outer surface of the first protrusion protrudes beyond an outer surface of the first base portion along the second direction, and an inner surface of the first protrusion is recessed relative to an inner surface of the first base portion in a direction away from the electrode assembly.

11. The electrical device according to claim 10, wherein the first sidewall further comprises a second protrusion, the second protrusion connects the first base portion and the fourth sidewall, an outer surface of the second protrusion protrudes beyond the outer surface of the first base portion along the second direction, and an inner surface of the second protrusion is recessed relative to the inner surface of the first base portion in the direction away from the electrode assembly.

12. The electrical device according to claim 10, wherein the electrochemical apparatus satisfies at least one of the following conditions:
(1) along the second direction, a distance between the outer surface of the first base portion and an outer surface of the second sidewall is L, and a height by which the first protrusion protrudes beyond the outer surface of the first base portion is l₁, wherein 0.005L≤l₁≤0.1L; or
(2) along the third direction, a distance between an outer surface of the third sidewall and an outer surface of the fourth sidewall is W, and a width of the first protrusion is w₁, wherein 0.05W≤w₁≤0.3W.

13. The electrical device according to claim 11, wherein the electrochemical apparatus satisfies at least one of the following conditions:
(1) along the second direction, a distance between the outer surface of the first base portion and an outer surface of the second sidewall is L, and a height by which the second protrusion protrudes beyond the outer surface of the first base portion is l₂, wherein 0.005L≤l₂≤0.1L; or
(2) along the third direction, a distance between an outer surface of the third sidewall and an outer surface of the fourth sidewall is W, and a width of the second protrusion is w₂, wherein 0.05W≤w₂≤0.3W.

14. The electrical device according to claim 11, wherein the electrochemical apparatus satisfies at least one of the following conditions:
(1) the third sidewall comprises a third base portion and a third protrusion, the third protrusion connects the third base portion and the first protrusion, an outer surface of the third protrusion protrudes beyond an outer surface of the third base portion along the third direction, and an inner surface of the third protrusion is recessed relative to an inner surface of the third base portion in the direction away from the electrode assembly; or
(2) the fourth sidewall comprises a fourth base portion and a fourth protrusion, the fourth protrusion connects the fourth base portion and the second protrusion, an outer surface of the fourth protrusion protrudes beyond an outer surface of the fourth base portion along the third direction, and an inner surface of the fourth protrusion is recessed relative to an inner surface of the fourth base portion in the direction away from the electrode assembly.

15. The electrical device according to claim 14, wherein the electrochemical apparatus satisfies at least one of the following conditions:
(1) along the third direction, a distance between the outer surface of the third base portion and an outer surface of the fourth sidewall is W, and a height by which the third protrusion protrudes beyond the outer surface of the third base portion is w₃, wherein 0.05W≤w₃≤0.3W; or
(2) along the second direction, a distance between the outer surface of the first base portion and an outer surface of the second sidewall is L, and a width of the third protrusion is 13, wherein 0.005L≤l₃≤0.1L;
(3) along the third direction, a distance between the outer surface of the fourth base portion and an outer surface of the third sidewall is W, and a height by which the fourth protrusion protrudes beyond the outer surface of the fourth base portion is w₄, wherein 0.05W≤w₄≤0.3W; or
(4) along the second direction, a distance between the outer surface of the first base portion and an outer surface of the second sidewall is L, and a width of the fourth protrusion is l₄, wherein 0.005L≤l₄≤0.1L.

16. The electrical device according to claim 14, wherein the electrochemical apparatus satisfies at least one of the following conditions:
(1) the first bottom wall comprises a first main portion and a fifth protrusion, the fifth protrusion is located in a corner region of the first bottom wall, the fifth protrusion connects the first protrusion and the third protrusion, an outer surface of the fifth protrusion protrudes beyond an outer surface of the first main portion along the first direction, and an inner surface of the fifth protrusion is recessed relative to an inner surface of the first main portion in the direction away from the electrode assembly; or
(2) the first bottom wall comprises a first main portion and a sixth protrusion, the sixth protrusion is located in a corner region of the first bottom wall, the sixth protrusion connects the second protrusion and the fourth protrusion, an outer surface of the sixth protrusion protrudes beyond an outer surface of the first main portion along the first direction, and an inner surface of the sixth protrusion is recessed relative to an inner surface of the first main portion in the direction away from the electrode assembly.

17. The electrical device according to claim 16, wherein a distance between the outer surface of the first main portion and an outer surface of the second bottom wall is T, and the electrochemical apparatus satisfies at least one of the following conditions:
(1) a height by which the fifth protrusion protrudes beyond the outer surface of the first main portion is t₁, wherein 0.05T≤t₁≤0.4T; or
(2) a height by which the sixth protrusion protrudes beyond the outer surface of the first main portion is t₂, wherein 0.05T≤t₂≤0.4T.

18. The electrical device according to claim 10, wherein the electrode assembly is a wound structure, and a winding axis of the wound structure is in the same direction as the second direction.
